(19) United States
(12) Patent Application Publication
(10) Pub. No.: US 2023/0264524 A1
(43) Pub. Date: Aug. 24, 2023

(54) PNEUMATIC TIRE

(71) Applicant: The Yokohama Rubber Co., LTD., Tokyo (JP)

(72) Inventors: Yuki NAGAHASHI, Kanagawa (JP); Masahiro NARUSE, Kanagawa (JP)

(21) Appl. No.: 18/002,895

(22) PCT Filed: Jun. 22, 2021
(86) PCT No.: PCT/JP2021/023535

§ 371 Date: Dec. 22, 2022

(30) Foreign Application Priority Data
Jun. 29, 2020 (JP) 2020-111377

(51) Int. Cl. B60C 19/00; B60C 9/00; B60C 15/00

(52) U.S. Cl. CPC B60C 19/00; B60C 9/0042; B60C 15/0036; B60C 2009/0085

(57) ABSTRACT

In a pneumatic tire in which a carcass layer is turned up from a tire inner side to a tire outer side around a bead core, the carcass layer is formed of a reinforcing cord made of a polyester fiber cord, elongation at break of the reinforcing cord of the carcass layer ranges from 20% to 30%, and a transponder is disposed between a position of an outer side in a tire radial direction by 15 mm from an upper end of the bead core and a position of an inner side in the tire radial direction by 5 mm from an end of a belt layer.

### TECHNICAL FIELD

The present technology relates to a pneumatic tire embedded with a transponder and relates particularly to a pneumatic tire that can provide improved steering stability of the tire and ensured communication performance of the transponder.

### BACKGROUND ART

For pneumatic tires, embedding an RFID (radio frequency identification) tag (transponder) in a tire has been proposed (see, for example, Japan Unexamined Patent Publication No. H07-137510 A). In addition, an organic fiber cord is used for a reinforcing cord (carcass cord) constituting a carcass layer, and examples of the organic fiber include rayon and polyester. For example, in a case where a transponder is embedded in a pneumatic tire in which a carcass layer is formed of a reinforcing cord made of a rayon fiber cord, excellent steering stability can be achieved because rayon has high rigidity, whereas communication performance of the transponder is degraded because rayon has high moisture-absorption properties. In addition, in a case where the transponder is embedded in a pneumatic tire in which a carcass layer is formed of a reinforcing cord made of a polyester fiber cord, sufficient steering stability may not be achieved because some types of polyester fibers have low rigidity (relatively high elongation at break).

### SUMMARY

The present technology provides a pneumatic tire that can provide improved steering stability of the tire and ensured communication performance of a transponder.

A pneumatic tire according to an embodiment of the present technology includes a tread portion extending in a tire circumferential direction and having an annular shape, a pair of sidewall portions respectively disposed on both sides of the tread portion, and a pair of bead portions disposed on an inner side of the sidewall portions in a tire radial direction. A bead filler is disposed on an outer circumference of a bead core of each of the bead portions, a carcass layer is mounted between the pair of bead portions, a plurality of belt layers is disposed on an outer circumferential side of the carcass layer in the tread portion, an innerliner layer is disposed on an inner surface of the tire along the carcass layer, and the carcass layer is turned up from a tire inner side to a tire outer side around the bead core. In the pneumatic tire, the carcass layer is formed of a reinforcing cord made of a polyester fiber cord, elongation at break EB of the reinforcing cord of the carcass layer ranges from 20% to 30%, and a transponder is disposed between a position of an outer side in the tire radial direction by 15 mm from an upper end of the bead core and a position of an inner side in the tire radial direction by 5 mm from ends of the belt layers.

In an embodiment of the present technology, the carcass layer is formed of the reinforcing cord made of a polyester fiber cord, and the elongation at break EB of the reinforcing cord of the carcass layer ranges from 20% to 30%, thus allowing good steering stability at the same level as the use of a known rayon fiber cord to be ensured. Further, the carcass layer is formed of the polyester fiber cord and has low moisture absorption properties, and thus the communication performance of the transponder is not degraded unlike the use of a known rayon fiber cord. Furthermore, the transponder is disposed between the position of an outer side in the tire radial direction by 15 mm from the upper end of the bead core and the position of an inner side in the tire radial direction by 5 mm from the ends of the belt layers, thus metal interference is less likely to occur, and the communication performance of the transponder can be sufficiently ensured. This can improve the steering stability of the tire while ensuring the communication performance of the transponder.

In a pneumatic tire according to an embodiment of the present technology, the transponder is preferably disposed between the carcass layer and a rubber layer disposed in the sidewall portion on an outer side of the carcass layer, or between the carcass layer and the innerliner layer. For example, in a case where the transponder is disposed between the carcass layer and the bead filler, a carcass line in the carcass layer is disturbed, and the steering stability of the tire is degraded. Instead, in a case where the transponder is disposed at a position in a tire width direction as described above, the carcass line in the carcass layer is not affected, and thus the steering stability of the tire and the communication performance of the transponder can be provided in a compatible manner.

The center of the transponder is preferably disposed 10 mm or more away from a splice portion of a tire component in the tire circumferential direction. Accordingly, tire durability can be effectively improved.

The intermediate elongation EM of the reinforcing cord of the carcass layer at a load of 1.0 cN/dtex is preferably 5.0% or less. Accordingly, the rigidity of the tire can be sufficiently ensured, and the steering stability on dry road surfaces can be effectively improved.

A fineness based on corrected weight CF of the reinforcing cord of the carcass layer is preferably within a range from 4000 dtex to 8000 dtex. Accordingly, the rigidity of the reinforcing cord of the carcass layer can be sufficiently ensured, and the steering stability on dry road surfaces can be effectively improved.

A twist coefficient CT of the reinforcing cord of the carcass layer after dip treatment is represented by the formula below and is preferably 2000 or greater. Accordingly, the rigidity of the reinforcing cord of the carcass layer can be sufficiently ensured, and the steering stability on dry road surfaces can be effectively improved.

CT=T×D^{1/2}
T: Number of twists of reinforcing cord of carcass layer (twists/10 cm)
D: Total fineness of reinforcing cord of carcass layer (dtex)

Preferably, the transponder is covered with a coating layer formed of elastomer or rubber, and the coating layer has a relative dielectric constant of 7 or less. Accordingly, the transponder is protected by the coating layer, allowing the durability of the transponder to be improved and also ensuring radio wave transmittivity of the transponder to allow the communication performance of the transponder to be effectively improved.

The total thickness Gac of the coating layer and the maximum thickness Gar of the transponder preferably satisfy the relationship 1.1≤Gac/Gar≤3.0. Accordingly, the communication distance of the transponder can be sufficiently ensured.

Preferably, the transponder includes a substrate and antennas extending from both ends of the substrate, the transponder extends along the tire circumferential direction, and a distance L between an end of the antenna in the tire circumferential direction and an end of the coating layer in the tire circumferential direction ranges from 2 mm to 20 mm. Accordingly, the communication distance of the transponder can be sufficiently ensured.

Preferably, the transponder includes a substrate and antennas extending from both ends of the substrate, and the antenna extends within a range of ±20° with respect to the tire circumferential direction. Thus, the durability of the transponder can be sufficiently ensured.

Preferably, the center of the transponder in a thickness direction is disposed within a range from 25% to 75% of the total thickness Gac of the coating layer from a surface on one side of the coating layer in a thickness direction. Accordingly, the communication distance of the transponder can be sufficiently ensured.

### BRIEF DESCRIPTION OF DRAWINGS

FIG. 1 is a meridian cross-sectional view illustrating an example of a pneumatic tire according to an embodiment of the present technology.

FIG. 2 is a meridian cross-sectional view schematically illustrating the pneumatic tire of FIG. 1.

FIGS. 3A and 3B are perspective views each illustrating a transponder that can be embedded in a pneumatic tire according to an embodiment of the present technology.

FIG. 4 is an enlarged meridian cross-sectional view illustrating a transponder embedded in the pneumatic tire of FIG. 1.

FIG. 5 is a cross-sectional view illustrating a transponder covered with a coating layer and embedded in a pneumatic tire.

FIGS. 6A to 6C are plan views each illustrating a transponder covered with a coating layer and embedded in a pneumatic tire.

FIGS. 7A and 7B are plan views each illustrating a transponder covered with a coating layer and embedded in a pneumatic tire.

FIG. 8 is an equatorial cross-sectional view schematically illustrating the pneumatic tire of FIG. 1.

FIG. 9 is a meridian cross-sectional view illustrating a pneumatic tire according to a modified example of an embodiment of the present technology.

FIG. 10 is an explanatory diagram illustrating the position of a transponder in a tire radial direction in a test tire.

### DETAILED DESCRIPTION

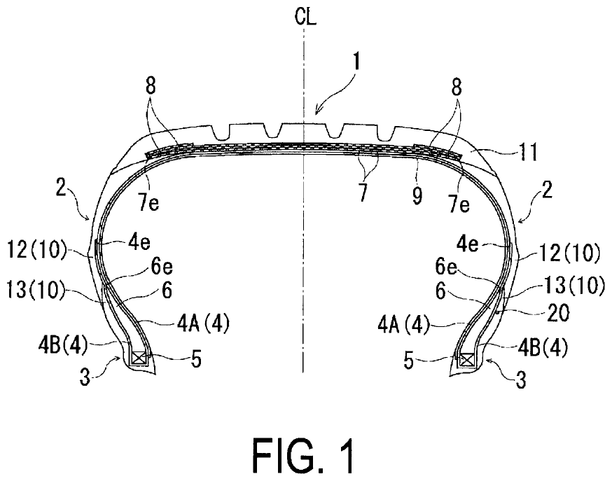

Configurations of embodiments of the present technology will be described in detail below with reference to the accompanying drawings. FIGS. 1 to 8 illustrate a pneumatic tire according to an embodiment of the present technology.

As illustrated in FIG. 1, the pneumatic tire according to the present embodiment includes a tread portion 1 extending in a tire circumferential direction and having an annular shape, a pair of sidewall portions 2 disposed on both sides of the tread portion 1, and a pair of bead portions 3 disposed on an inner side in a tire radial direction of the pair of sidewall portions 2.

At least one carcass layer 4 (one layer in FIG. 1) formed by arranging a plurality of reinforcing cords (carcass cords) in the radial direction is mounted between the pair of bead portions 3. Bead cores 5 having an annular shape are embedded within the bead portions 3, and bead fillers 6 made of a rubber composition and having a triangular cross-section are disposed on the outer peripheries of the bead cores 5.

On the other hand, a plurality of belt layers 7 (two layers in FIG. 1) are embedded on a tire outer circumferential side of the carcass layer 4 of the tread portion 1. The belt layers 7 include a plurality of reinforcing cords that are inclined with respect to the tire circumferential direction, and the reinforcing cords are disposed between layers so as to intersect each other. In the belt layers 7, the inclination angle of the reinforcing cords with respect to the tire circumferential direction is set to fall within a range of from 10° to 40°, for example. Steel cords are preferably used as the reinforcing cords of the belt layers 7.

To improve high-speed durability, at least one belt cover layer 8 (two layers in FIG. 1) formed by arranging reinforcing cords at an angle of, for example, 5° or less with respect to the tire circumferential direction is disposed on a tire outer circumferential side of the belt layers 7. In FIG. 1, the belt cover layer 8 located on the inner side in the tire radial direction constitutes a full cover that covers the entire width of the belt layers 7, and the belt cover layer 8 located on an outer side in the tire radial direction constitutes an edge cover layer that covers only end portions of the belt layers 7. Organic fiber cords such as nylon and aramid are preferably used as the reinforcing cords of the belt cover layer 8.

In the pneumatic tire described above, both ends 4e of the carcass layer 4 are folded back from the tire inner side to the tire outer side around the bead cores 5 and are disposed wrapping around the bead cores 5 and the bead fillers 6. The carcass layer 4 includes: a body portion 4A corresponding to a portion extending from the tread portion 1 through each of the sidewall portions 2 to each of the bead portions 3; and a turned-up portion 4B corresponding to a portion turned up around the bead core 5 at each of the bead portions 3 and extending toward each sidewall portion 2 side.

Additionally, on a tire inner surface, an innerliner layer 9 is disposed along the carcass layer 4. Furthermore, a cap tread rubber layer 11 is disposed in the tread portion 1, a sidewall rubber layer 12 is disposed in the sidewall portion 2, and a rim cushion rubber layer 13 is disposed in the bead portion 3. A rubber layer 10 disposed on the outer side of the carcass layer 4 in the sidewall portion 2 includes the sidewall rubber layer 12 and the rim cushion rubber layer 13.

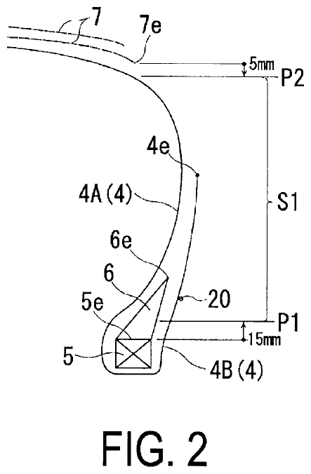

Additionally, in the pneumatic tire described above, a transponder 20 is embedded between the turned-up portion 4B of the carcass layer 4 and the rubber layer 10. In other words, the transponder 20 is disposed between the turned-up portion 4B of the carcass layer 4 and the sidewall rubber layer 12 or the rim cushion rubber layer 13 as an arrangement region in the tire width direction. Additionally, as an arrangement region in the tire radial direction, the transponder 20 is disposed between a position P1 of an outer side in the tire radial direction by 15 mm from an upper end 5e of the bead core 5 (an end portion 5e on the outer side in the tire radial direction) and a position P2 of an inner side in the tire radial direction by 5 mm from an end 7e of the belt layer 7. In other words, the transponder 20 is disposed in a region S1 illustrated in FIG. 2.

Note that in the embodiment of FIGS. 1 and 2, an example has been illustrated in which the end 4e of the turned-up portion 4B of the carcass layer 4 is disposed halfway up the sidewall portion 2. However, the end 4e of the turned-up portion 4B of the carcass layer 4 can be disposed laterally to the bead core 5. In such a low turned-up structure, the transponder 20 is disposed between the bead filler 6 and the sidewall rubber layer 12 or the rim cushion rubber layer 13.

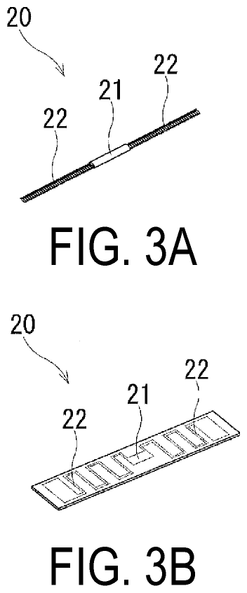

As the transponder 20, for example, a radio frequency identification (RFID) tag can be used. As illustrated in FIGS. 3A and 3B, the transponder 20 includes a substrate 21 that stores data and antennas 22 that transmit and receive data in a non-contact manner. By using the transponder 20 as described above to write or read information related to the tire on a timely basis, the tire can be efficiently managed. Note that “RFID” refers to an automatic recognition technology including: a reader/writer including an antenna and a controller; and an ID (identification) tag including a substrate and an antenna, the automatic recognition technology allowing data to be communicated in a wireless manner.

The overall shape of the transponder 20 is not limited to particular shapes and can use a pillar- or plate-like shape as illustrated in, for example, FIGS. 3A and 3B. In particular, using the transponder 20 having a pillar-like shape illustrated in FIG. 3A can suitably follow the deformation of the tire in each direction. In this case, the antennas 22 of the transponder 20 each project from both end portions of the substrate 21 and exhibit a helical shape. This allows the transponder 20 to follow the deformation of the tire during traveling, allowing the durability of the transponder 20 to be improved. Additionally, by appropriately changing the length of the antenna 22, the communication performance can be ensured.

In the pneumatic tire configured as described above, the carcass layer 4 is formed of the reinforcing cords (carcass cords) made of polyester fiber cords. The elongation at break EB of the reinforcing cord of the carcass layer 4 is set to a range from 20% to 30%. Preferably, the elongation at break EB of the reinforcing cord of the carcass layer 4 ranges from 22% to 28%. The reinforcing cord of the carcass layer 4 used in an embodiment of the present technology has the same degree of rigidity as a rayon fiber cord and has low moisture absorption properties of a polyester fiber cord. Note that “elongation at break” is an elongation ratio (%) of a sample cord measured when the cord is broken by conducting a tensile test in accordance with JIS (Japanese Industrial Standard) L1017 “Test methods for chemical fiber tire cords” with a length of specimen between grips being 250 mm and a tensile speed being 300±20 mm/minute.

Fibers constituting the reinforcing cord (polyester fiber cord) of the carcass layer 4 are not limited to particular types, and examples of the fibers include a polyethylene terephthalate fiber (PET fiber), a polyethylene naphthalate fiber (PEN fiber), a polybutylene terephthalate fiber (PBT), and a polybutylene naphthalate fiber (PBN). Of these, the PET fiber is suitable. No matter which fiber is used, physical properties of each fiber can provide good steering stability. In particular, in the case of PET fibers, since the PET fibers are inexpensive, the cost of the pneumatic tire can be reduced. In addition, workability in producing cords can be increased.

In the pneumatic tire described above, the carcass layer 4 is formed of the reinforcing cord made of a polyester fiber cord and the elongation at break EB of the reinforcing cord of the carcass layer 4 ranges from 20% to 30%. This can ensure good steering stability at the same level as the use of a known rayon fiber cord. Further, since the carcass layer 4 is formed of the polyester fiber cord that has low moisture absorption properties, the communication performance of the transponder 20 is not degraded unlike the use of a known rayon fiber cord. Furthermore, the transponder 20 is disposed between the position P1 of an outer side in the tire radial direction by 15 mm from the upper end 5e of the bead core 5 and the position P2 of an inner side in the tire radial direction by 5 mm from the end 7e of the belt layer 7, thus metal interference is less likely to occur, and the communication performance of the transponder 20 can be sufficiently ensured. This can improve the steering stability of the tire while ensuring the communication performance of the transponder 20.

Here, when the elongation at break EB of the reinforcing cord of the carcass layer 4 exceeds 30%, the intermediate elongation of the reinforcing cord also tends to increase, and thus the rigidity of the reinforcing cord decreases, and the steering stability of the tire is degraded. Also, in a case where the transponder 20 is disposed on the inner side of the position P1 in the tire radial direction, metal interference with a rim flange occurs, and the communication performance of the transponder 20 tends to be reduced.

Additionally, in a case where the transponder 20 is disposed further on the outer side than the position P2 in the tire radial direction, metal interference with the belt layer 7 occurs, leading to the tendency to degrade the communication performance of the transponder 20.

In the pneumatic tire described above, the transponder 20 is preferably disposed between the carcass layer 4 and the rubber layer 10 (the sidewall rubber layer 12 or the rim cushion rubber layer 13) in contact with the rubber layer 10. For example, in a case where the transponder 20 is disposed between the carcass layer 4 and rubber layer 10 and more specifically between the carcass layer 4 and the bead filler 6, a carcass line in the carcass layer 4 is disturbed, and the steering stability of the tire tends to be degraded. Instead, in a case where the transponder 20 is disposed at a position in the tire width direction as described above, the carcass line in the carcass layer 4 is not adversely affected, and thus the steering stability of the tire and the communication performance of the transponder 20 can be provided in a compatible manner.

In the pneumatic tire described above, the intermediate elongation EM of the reinforcing cord of the carcass layer 4 at a load of 1.0 cN/dtex is preferably 5.0% or less, and more preferably within a range from 2.0% to 4.0%. Accordingly, appropriately setting the intermediate elongation EM of the reinforcing cord of the carcass layer 4 can sufficiently ensure the rigidity of the tire and can effectively improve the steering stability on dry road surfaces. Here, when the intermediate elongation EM of the reinforcing cord of the carcass layer 4 at a load of 1.0 cN/dtex exceeds 5.0%, the rigidity cannot be sufficiently ensured and the effect of improving the steering stability may b e limited. Note that the “intermediate elongation at a load of 1.0 cN/dtex” is an elongation ratio (%) of a sample cord measured at a load of 1.0 cN/dtex by conducting a tensile test in accordance with JIS L1017 “Test methods for chemical fiber tire cords” with a length of specimen between grips being 250 mm and a tensile speed being 300±20 mm/minute.

Also, a fineness based on corrected weight CF of the reinforcing cord of the carcass layer 4 preferably ranges from 4000 dtex to 8000 dtex and more preferably ranges from 5000 dtex to 7000 dtex. Accordingly, appropriately setting the fineness based on corrected weight CF of the reinforcing cord of the carcass layer 4 can sufficiently ensure the rigidity of the reinforcing cord of the carcass layer 4 and can effectively improve the steering stability on dry road surfaces. Here, when the fineness based on corrected weight CF of the reinforcing cord of the carcass layer 4 is less than 4000 dtex, it is difficult to sufficiently ensure the steering stability. On the other hand, when the fineness based on corrected weight CF of the reinforcing cord of the carcass layer 4 exceeds 8000 dtex, ride comfort tends to be degraded.

Further, a twist coefficient CT of the reinforcing cord of the carcass layer 4 after dip treatment is represented by the formula below and is preferably 2000 or greater and more preferably ranges from 2100 to 2400. Accordingly, appropriately setting the twist coefficient CT of the reinforcing cord of the carcass layer 4 can sufficiently ensure the rigidity of the reinforcing cord of the carcass layer 4 and can effectively improve the steering stability on dry road surfaces. This can mitigate cord fatigue, and thus excellent durability can be ensured. Here, when the twist coefficient CT of the reinforcing cord of the carcass layer 4 is less than 2000, the rigidity cannot be sufficiently ensured, and the effect of improving the steering stability may be limited.

CT=T×D^{1/2}
T: Number of twists of reinforcing cord of carcass layer (twists/10 cm)
D: Total fineness of reinforcing cord of carcass layer (dtex)

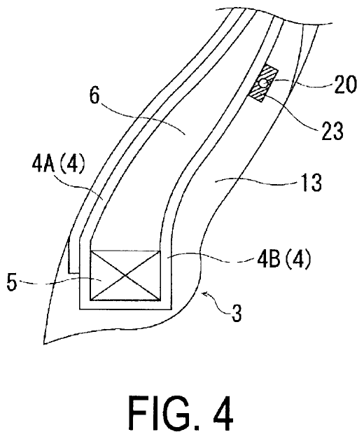

As illustrated in FIG. 4, the transponder 20 is preferably covered with a coating layer 23 formed of elastomer or rubber. The coating layer 23 coats the entire transponder 20 while holding both front and rear sides of the transponder 20. The coating layer 23 may be formed from rubber having physical properties identical to those of the rubber constituting the sidewall rubber layer 12 or the rim cushion rubber layer 13 or from rubber having different physical properties. The transponder 20 is protected by the coating layer 23 as described above, and thus the durability of the transponder 20 can be improved. Note that the cross-sectional shape of the coating layer 23 is not limited to particular shapes and can adopt, for example, a triangular shape, a rectangular shape, a trapezoidal shape, and a spindle shape.

As the composition of the coating layer 23, the coating layer 23 is preferably made of rubber or elastomer and 20 phr or more of white filler. The relative dielectric constant can be set relatively lower for the coating layer 23 configured as described above than for the coating layer 23 containing carbon, allowing the communication performance of the transponder 20 to be effectively improved. Note that “phr” as used herein means parts by weight per 100 parts by weight of the rubber component (elastomer).

The white filler constituting the coating layer 23 preferably includes from 20 phr to 55 phr of calcium carbonate. This enables a relatively low relative dielectric constant to be set for the coating layer 23, allowing the communication performance of the transponder 20 to be effectively improved. However, the white filler with an excessive amount of calcium carbonate contained is brittle, and the strength of the coating layer 23 decreases. This is not preferable. Additionally, the coating layer 23 can optionally contain, in addition to calcium carbonate, 20 phr or less of silica (white filler) or 5 phr or less of carbon black. In a case where a small amount of silica or carbon black is used with the coating layer 23, the relative dielectric constant of the coating layer 23 can be reduced while ensuring the strength of the coating layer 23.

In addition, the coating layer 23 preferably has a relative dielectric constant of 7 or less, and more preferably from 2 to 5. By properly setting the relative dielectric constant of the coating layer 23 as described above, radio wave transmittivity can be ensured during emission of a radio wave by the transponder 20, effectively improving the communication performance of the transponder 20. Note that the rubber constituting the coating layer 23 has a relative dielectric constant of from 860 MHz to 960 MHz at ambient temperature. In this regard, the ambient temperature is 23±2° C. and 60%±5% RH (relative humidity) in accordance with the standard conditions of the JIS standard. The relative dielectric constant of the rubber is measured after 24 hour treatment at 23° C. and 60% RH. The range from 860 MHz to 960 MHz described above corresponds to currently allocated frequencies of the RFID in a UHF band, but in a case where the allocated frequencies are changed, the relative dielectric constant in the range of the allocated frequencies may be specified as described above.

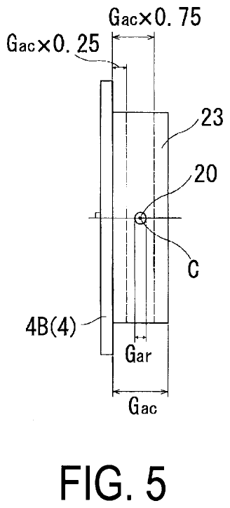

In the pneumatic tire described above, the total thickness Gac of the coating layer 23 and the maximum thickness Gar of the transponder 20 preferably satisfy the relationship 1.1≤Gac/Gar≤3.0. Here, the total thickness Gac of the coating layer 23 is the total thickness of the coating layer 23 at a position including the transponder 20, and is, for example, as illustrated in FIG. 5, the total thickness on a straight line passing through the center C of the transponder 20 and perpendicularly intersecting the closest carcass cord of the carcass layer 4 in a tire meridian cross-section.

As described above, appropriately setting the ratio of the total thickness Gac of the coating layer 23 to the maximum thickness Gar of the transponder can sufficiently ensure the communication distance of the transponder 20. Here, when the above-described ratio is excessively small (the total thickness Gac of the coating layer 23 is excessively thin), the transponder 20 comes into contact with an adjacent rubber member, resonant frequency is shifted, and the communication performance of the transponder 20 is degraded. On the other hand, when the above-described ratio is excessively large (the total thickness Gac of the coating layer 23 is excessively thick), the tire durability tends to be degraded.

As illustrated in FIG. 5, in the pneumatic tire described above, the center C of the transponder 20 in a thickness direction is preferably disposed within a range of from 25% to 75% of the total thickness Gac of the coating layer 23 from a surface on one side in a thickness direction of the coating layer 23. Accordingly, the transponder 20 is securely covered with the coating layer 23, and thus the surrounding environment of the transponder 20 becomes stable and the communication distance of the transponder 20 can be sufficiently ensured without causing the shifting of the resonant frequency.

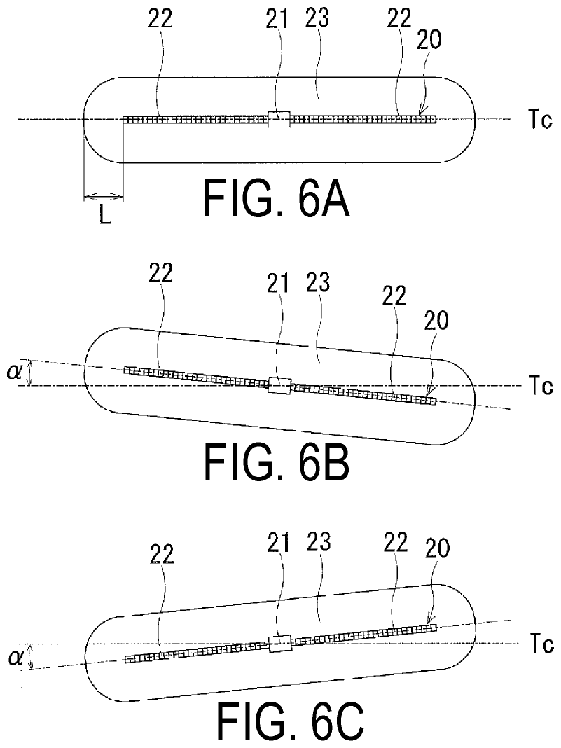

As illustrated in FIGS. 6A to 6C, in the pneumatic tire described above, preferably, the transponder 20 includes the substrate 21 and the antennas 22 extending from both ends of the substrate 21, and the transponder 20 extends along the tire circumferential direction Tc. More specifically, an inclination angle α of the transponder 20 with respect to the tire circumferential direction is preferably within a range of ±20°. Also, a distance L between an end of the antenna 22 in the tire circumferential direction and an end of the coating layer 23 in the tire circumferential direction preferably ranges from 2 mm to 20 mm. Accordingly, the transponder 20 is completely and securely covered with the coating layer 23, and thus the communication distance of the transponder 20 can be sufficiently ensured.

Here, when the absolute value of the inclination angle α of the transponder 20 with respect to the tire circumferential direction Tc is greater than 20°, the durability of the transponder 20 against repeated deformation of the tire during travel is degraded. Also, when the distance L between the end of the antenna 22 in the tire circumferential direction and the end of the coating layer 23 in the tire circumferential direction is less than 2 mm, there is a concern that the end of the antenna 22 in the tire circumferential direction may protrude from the coating layer 23, the antenna 22 may be damaged during travel, and the communication distance after travel may be reduced. On the other hand, when the distance L is greater than 20 mm, a local increase in weight occurs on the tire circumference, causing deterioration in tire balance.

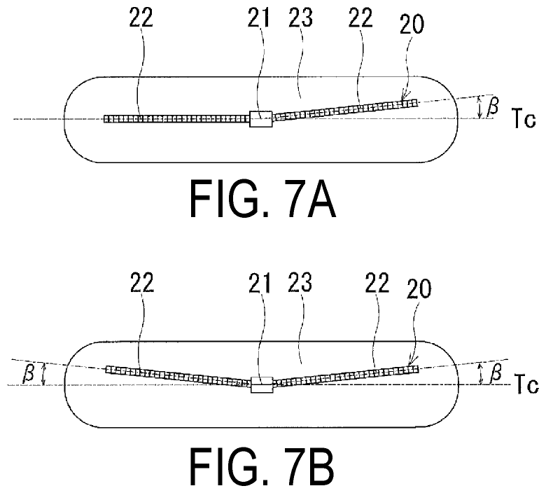

As illustrated in FIGS. 7A and 7B, in the pneumatic tire described above, the transponder 20 includes the substrate 21 and the antennas 22 extending from both ends of the substrate 21, and at least one of the antennas 22 may extend so as to bend with respect to the substrate 21. In this case, an angle β of each antenna 22 with respect to the tire circumferential direction Tc is preferably within a range of ±20°. By regulating the inclination of the antennas 22 constituting the transponder 20 as described above, the durability of the transponder 20 can be sufficiently ensured.

Here, when the absolute value of the inclination angle β of the transponder 20 with respect to the tire circumferential direction Tc is greater than 20°, stress concentrates on a base end portion of the antenna 22 due to repeated deformation of the tire during travel and thus the durability of the transponder 20 is degraded. Note that, the antenna 22 is not necessarily a straight line, and the inclination angle β of the antenna 22 is an angle formed by a straight line connecting the base end and the tip of the antenna 22 with respect to the tire circumferential direction.

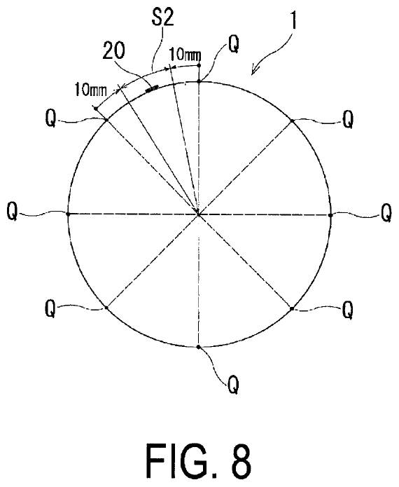

As illustrated in FIG. 8, a plurality of splice portions formed by overlaying end portions of the tire component are present on the tire circumference. FIG. 8 illustrates a position Q of each splice portion in the tire circumferential direction. The center of the transponder 20 is preferably disposed 10 mm or more away from the splice portion of the tire component in the tire circumferential direction. In other words, the transponder 20 is preferably disposed in a region S2 illustrated in FIG. 8. Specifically, the substrate 21 constituting the transponder 20 is preferably located 10 mm or more away from the position Q in the tire circumferential direction.

Furthermore, the entire transponder 20 including the antenna 22 is more preferably located 10 mm or more away from the position Q in the tire circumferential direction, and the entire transponder 20 covered with the coating rubber is most preferably located 10 mm or more away from the position Q in the tire circumferential direction. In addition, the tire component in which the splice portion is disposed away from the transponder 20 is preferably a member adjacent to the transponder 20. Examples of such a tire component include the carcass layer 4, the bead filler 6, the sidewall rubber layer 12, and the rim cushion rubber layer 13. Disposing the transponder 20 away from the splice portion of the tire component as described above can effectively improve tire durability.

Note that the embodiment of FIG. 8 illustrates an example in which the position Q of the splice portion of each tire component in the tire circumferential direction is disposed at equal intervals, but no such limitation is intended. The position Q in the tire circumferential direction can be set at any position, and in either case, the transponder 20 is disposed 10 mm or more away from the splice portion of each tire component in the tire circumferential direction.

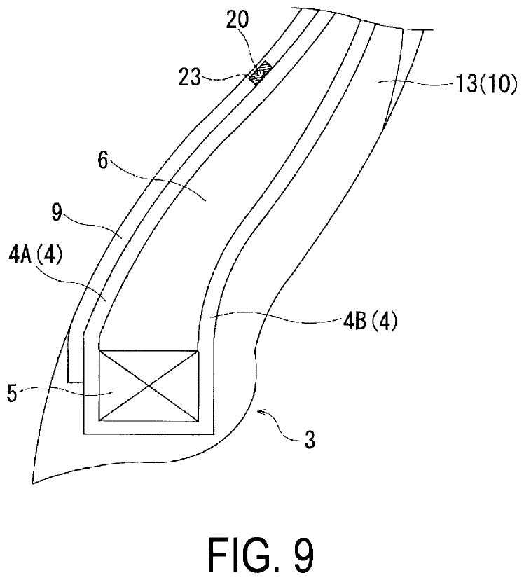

FIG. 9 illustrates a modified example of a pneumatic tire according to an embodiment of the present technology. In FIG. 9, components that are identical to those in FIGS. 1 to 8 have the same reference signs, and detailed descriptions of those components are omitted.

As illustrated in FIG. 9, the transponder 20 is disposed between the carcass layer 4 and the innerliner layer 9. Disposing the transponder 20 as described above can prevent the transponder 20 from being damaged due to damage of the sidewall portion 2. In addition, the tire component whose splice portions are disposed away from the transponder 20 is preferably a member adjacent to the transponder 20. Examples of such a tire component include the carcass layer 4 and the innerliner layer 9. Disposing the transponder 20 away from the splice portions of the tire component as described above can effectively improve tire durability.

### EXAMPLES

Tires according to Comparative Examples 1 to 6 and Examples 1 to 16 were manufactured. Pneumatic tires have a tire size of 235/60R18 and include a tread portion extending in the tire circumferential direction and having an annular shape, a pair of sidewall portions respectively disposed on both sides of the tread portion, and a pair of bead portions each disposed on an inner side of the sidewall portions in the tire radial direction. A bead filler is disposed on an outer circumference of a bead core of each bead portion, a carcass layer is mounted between the pair of bead portions, a plurality of belt layers is disposed on an outer circumferential side of the carcass layer in the tread portion, an innerliner layer is disposed on an inner surface of the tire along the carcass layer, and the carcass layer is turned up from the tire inner side to the tire outer side around the bead core. In the pneumatic tires, a transponder is embedded, and the position of the transponder (tire width direction, tire radial direction, and tire circumferential direction), a reinforcing cord of the carcass layer (constituent material, elongation at break EB, intermediate elongation EM, fineness based on corrected weight CF, and twist coefficient CT), a coating layer (constituent material, relative dielectric constant, and Gac/Gar) are set as shown in Tables 1 and 2.

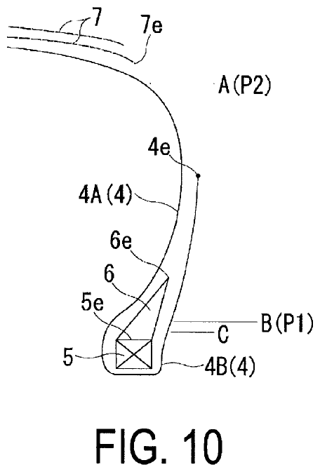

Note that, in Tables 1 and 2, the position “W” of the transponder (tire width direction) indicates that the transponder is disposed between the carcass layer and the bead filler, the position “X” of the transponder (tire width direction) indicates that the transponder is disposed between the carcass layer and the sidewall rubber layer in contact with the sidewall rubber layer, the position “Y” of the transponder (tire width direction) indicates that the transponder is disposed between the carcass layer and the rim cushion rubber layer in contact with the rim cushion rubber layer, and the position “Z” of the transponder (tire width direction) indicates that the transponder is disposed between the carcass layer and the innerliner layer. The position of the transponder (tire radial direction) corresponds to each of the positions A to C illustrated in FIG. 10. The position of the transponder (tire circumferential direction) indicates the distance (mm) measured from the center of the transponder to the splice portion of the tire component in the tire circumferential direction.

Tire evaluation (steering stability and durability) and transponder evaluation (communication performance) were conducted on the test tires using a test method described below, and the results are shown in Tables 1 and 2.

Steering Stability (Tire):

Each test tire was mounted on a wheel with a standard rim, the wheel was mounted on a test vehicle, and sensory evaluation by a test driver was conducted on a test course. The evaluation results are expressed in four levels: “Excellent” indicates that the result is very good, “Good” indicates that the result is good, “Fair” indicates that the result is slightly inferior, and “Poor” indicates that the result is considerably inferior.

Durability (Tire):

Each of the test tires was mounted on a wheel of a standard rim, and a traveling test was performed by using a drum testing machine at an air pressure of 120 kPa, a maximum load of 102%, and a traveling speed of 81 km/h, and the traveling distance at the time of a failure in the tire was measured. Evaluation results are expressed in three levels: “Excellent” indicates that the traveling distance reached 6480 km, “Good” indicates that the traveling distance was 4050 km or more and less than 6480 km, “Fair” indicates that the traveling distance was less than 4050 km.

Communication Performance (Transponder):

For each test tire, a communication operation with the transponder was performed using a reader/writer. Specifically, the maximum communication distance was measured with the reader/writer at a power output of 250 mW and a carrier frequency of from 860 MHz to 960 MHz. Evaluation results are expressed in four levels: “Excellent” indicates that the communication distance was 1000 mm or more, “Good” indicates that the communication distance was 500 mm or more and less than 1000 mm, “Fair” indicates that the communication distance was 250 mm or more and less than 500 mm, and “Poor” indicates that the communication distance was less than 250 mm.

TABLE 1

| | | Comparative | Comparative | Comparative |
|---|---|---|---|---|
| | | Example 1 | Example 2 | Example 3 |
| Position of | Tire width direction | Y | Y | Y |
| transponder | Tire radial direction | C | C | B |
| | Tire circumferential | 10 | 10 | 10 |
| | direction (mm) | | | |
| Reinforcing | Constituent material | Rayon | Polyester | Polyester |
| cord of | Elongation at break | 13 | 34 | 34 |
| carcass layer | EB (%) | | | |
| | Intermediate elongation | 6 | 6 | 6 |
| | EM (%) | | | |
| | Fineness based on | 3900 | 3900 | 3900 |
| | corrected weight CF | | | |
| | (dtex) | | | |
| | Twist coefficient CT | 1900 | 1900 | 1900 |
| Coating layer | Constituent material | — | — | — |
| | Relative dielectric | — | — | — |
| | constant | | | |
| | Gac/Gar | — | — | — |
| Tire evaluation | Steering stability | Good | Fair | Fair |
| | Durability | Excellent | Good | Good |
| Transponder | Communication | Poor | Fair | Good |
| evaluation | performance | | | |

| | | Comparative | Example | Example | Comparative |
|---|---|---|---|---|---|
| | | Example 4 | 1 | 2 | Example 5 |
| Position of | Tire width direction | Y | Y | X | W |
| transponder | Tire radial direction | B | B | A | B |
| | Tire circumferential | 10 | 10 | 10 | 10 |
| | direction (mm) | | | | |
| Reinforcing | Constituent material | Rayon | Polyester | Polyester | Rayon |
| cord of | Elongation at break | 13 | 20 | 20 | 13 |
| carcass layer | EB (%) | | | | |
| | Intermediate elongation | 6 | 6 | 6 | 6 |
| | EM (%) | | | | |
| | Fineness based on | 3900 | 3900 | 3900 | 3900 |
| | corrected weight CF | | | | |
| | (dtex) | | | | |
| | Twist coefficient CT | 1900 | 1900 | 1900 | 1900 |
| Coating layer | Constituent material | — | — | — | — |
| | Relative dielectric | — | — | — | — |
| | constant | | | | |
| | Gac/Gar | — | — | — | — |
| Tire evaluation | Steering stability | Good | Good | Good | Poor |
| | Durability | Excellent | Excellent | Excellent | Excellent |
| Transponder | Communication | Fair | Good | Good | Fair |
| evaluation | performance | | | | |
| | | Comparative | Example | Example | Example |
| | | Example 6 | 3 | 4 | 5 |
| Position of | Tire width direction | W | W | Z | Z |
| transponder | Tire radial direction | B | B | B | B |
| | Tire circumferential | 10 | 10 | 10 | 5 |
| | direction (mm) | | | | |
| Reinforcing | Constituent material | Polyester | Polyester | Polyester | Polyester |
| cord of | Elongation at break | 34 | 20 | 20 | 20 |
| carcass layer | EB (%) | | | | |
| | Intermediate elongation | 6 | 6 | 6 | 6 |
| | EM (%) | | | | |
| | Fineness based on | 3900 | 3900 | 3900 | 3900 |
| | corrected weight CF | | | | |
| | (dtex) | | | | |
| | Twist coefficient CT | 1900 | 1900 | 1900 | 1900 |
| Coating layer | Constituent material | — | — | — | — |
| | Relative dielectric | — | — | — | — |
| | constant | | | | |
| | Gac/Gar | — | — | — | — |
| Tire evaluation | Steering stability | Poor | Fair | Good | Good |
| | Durability | Good | Excellent | Excellent | Good |
| Transponder | Communication | Good | Good | Good | Good |
| evaluation | performance | | | | |

TABLE 2

| | | Example | Example | Example | Example |
|---|---|---|---|---|---|
| | | 6 | 7 | 8 | 9 |
| Position of | Tire width direction | X | X | X | X |
| transponder | Tire radial direction | A | A | A | A |
| | Tire circumferential | 10 | 10 | 10 | 10 |
| | direction [mm] | | | | |
| Reinforcing | Constituent material | Polyester | Polyester | Polyester | Polyester |
| cord of | Elongation at break | 20 | 20 | 20 | 20 |
| carcass layer | EB [%] | | | | |
| | Intermediate elongation | 3 | 3 | 3 | 3 |
| | EM [%] | | | | |
| | Fineness based on | 3900 | 6400 | 6400 | 6400 |
| | corrected weight CF | | | | |
| | [dtex] | | | | |
| | Twist coefficient CT | 1900 | 1900 | 2100 | 2100 |
| Coating layer | Constituent material | — | — | — | Resin |
| | Relative dielectric | — | — | — | 7 |
| | constant | | | | |
| | Gac/Gar | — | — | — | 2.0 |
| Tire evaluation | Steering stability | Good | Good | Excellent | Excellent |
| | Durability | Excellent | Excellent | Excellent | Good |
| Transponder | Communication | Good | Good | Good | Excellent |
| evaluation | performance | | | | |
| | | Example | Example | Example | Example |
| | | 10 | 11 | 12 | 13 |
| Position of | Tire width direction | X | X | X | X |
| transponder | Tire radial direction | A | A | A | A |
| | Tire circumferential | 10 | 10 | 10 | 10 |
| | direction [mm] | | | | |
| Reinforcing | Constituent material | Polyester | Polyester | Polyester | Polyester |
| cord of | Elongation at break | 20 | 20 | 20 | 20 |
| carcass layer | EB [%] | | | | |
| | Intermediate elongation | 3 | 3 | 3 | 3 |
| | EM [%] | | | | |
| | Fineness based on | 6400 | 6400 | 6400 | 6400 |
| | corrected weight CF | | | | |
| | [dtex] | | | | |
| | Twist coefficient CT | 2100 | 2100 | 2100 | 2100 |
| Coating layer | Constituent material | Rubber | Rubber | Rubber | Rubber |
| | Relative dielectric | 3.5 | 7 | 8 | 7 |
| | constant | | | | |
| | Gac/Gar | 2.0 | 2.0 | 2.0 | 1.0 |
| Tire evaluation | Steering stability | Excellent | Excellent | Excellent | Excellent |
| | Durability | Excellent | Excellent | Excellent | Excellent |
| Transponder | Communication | Excellent | Excellent | Good | Good |
| evaluation | performance | | | | |

| | | Example | Example | Example |
|---|---|---|---|---|
| | | 14 | 15 | 16 |
| Position of | Tire width direction | X | X | X |
| transponder | Tire radial direction | A | A | A |
| | Tire circumferential | 10 | 10 | 10 |
| | direction [mm] | | | |
| Reinforcing | Constituent material | Polyester | Polyester | Polyester |
| cord of | Elongation at break | 20 | 20 | 20 |
| carcass layer | EB [%] | | | |
| | Intermediate elongation | 3 | 3 | 3 |
| | EM [%] | | | |
| | Fineness based on | 6400 | 6400 | 6400 |
| | corrected weight CF | | | |
| | [dtex] | | | |
| | Twist coefficient CT | 2100 | 2100 | 2100 |
| Coating layer | Constituent material | Rubber | Rubber | Rubber |
| | Relative dielectric | 7 | 7 | — |
| | constant | | | |
| | Gac/Gar | 1.1 | 3.0 | 3.1 |
| Tire evaluation | Steering stability | Excellent | Excellent | Excellent |
| | Durability | Excellent | Excellent | Good |
| Transponder | Communication | Excellent | Excellent | Excellent |
| evaluation | performance | | | |

As can be seen from Tables 1 and 2, in Examples 1 to 16, the steering stability of the tire and the communication performance of the transponder were improved in a well-balanced manner. In particular, in Examples 1 to 4, 6 to 8, and 10 to 15, a sufficient effect of improving the tire durability was obtained.

On the other hand, in Comparative Example 1, the reinforcing cord of the carcass layer was made of a rayon fiber cord and the transponder was deviated to an inner side in the tire radial direction from the range defined in an embodiment of the present technology, degrading the communication performance of the transponder. In Comparative Example 2, the elongation at break of the reinforcing cord of the carcass layer was set to be higher than the range defined in an embodiment of the present technology, causing the insufficient effect of improving the steering stability and the durability of the tire. Moreover, the transponder was deviated to an inner side in the tire radial direction from the range defined in an embodiment of the present technology, and thus the communication performance of the transponder was not sufficiently ensured. In Comparative Example 3, the elongation at break of the reinforcing cord of the carcass layer was set to be higher than the range defined in an embodiment of the present technology, causing the insufficient effect of improving the steering stability and the durability of the tire. In Comparative Example 4, the reinforcing cord of the carcass layer was made of a rayon fiber cord, and thus the communication performance of the transponder was not sufficiently ensured.

In Comparative Example 5, the transponder was disposed between the carcass layer and the bead filler, degrading the steering stability of the tire. Moreover, the reinforcing cord of the carcass layer was made of a rayon fiber cord, and thus the communication performance of the transponder was not sufficiently ensured. In Comparative Example 6, the transponder was disposed between the carcass layer and the bead filler, and the elongation at break of the reinforcing cord of the carcass layer was set to be higher than the range defined in an embodiment of the present technology. This degraded the steering stability of the tire, causing the insufficient effect of improving the tire durability.

1. A pneumatic tire, comprising:
a tread portion extending in a tire circumferential direction and having an annular shape;
a pair of sidewall portions respectively disposed on both sides of the tread portion; and
a pair of bead portions each disposed on an inner side of the sidewall portions in a tire radial direction;
a bead filler being disposed on an outer circumference of a bead core of each of the bead portions,
a carcass layer being mounted between the pair of bead portions,
a plurality of belt layers being disposed on an outer circumferential side of the carcass layer in the tread portion,
an innerliner layer being disposed on an inner surface of the tire along the carcass layer,
the carcass layer being turned up from a tire inner side to a tire outer side around the bead core,
the carcass layer being formed of a reinforcing cord made of a polyester fiber cord,
elongation at break EB of the reinforcing cord of the carcass layer ranging from 20% to 30%, and
a transponder being disposed between a position of an outer side in the tire radial direction by 15 mm from an upper end of the bead core and a position of an inner side in the tire radial direction by 5 mm from ends of the belt layers.

2. The pneumatic tire according to claim 1, wherein the transponder is disposed between the carcass layer and a rubber layer disposed on an outer side of the carcass layer in the sidewall portions or between the carcass layer and the innerliner layer.

3. The pneumatic tire according to claim 1, wherein a center of the transponder is disposed 10 mm or more away from a splice portion of a tire component in the tire circumferential direction.

4. The pneumatic tire according to any one of claim 1, wherein an intermediate elongation EM of the reinforcing cord of the carcass layer at a load of 1.0 cN/dtex is 5.0% or less.

5. The pneumatic tire according to claim 1, wherein a fineness based on corrected weight CF of the reinforcing cord of the carcass layer ranges from 4000 dtex to 8000 dtex.

6. The pneumatic tire according to claim 1, wherein a twist coefficient CT of the reinforcing cord of the carcass layer after dip treatment represented by a formula below is 2000 or greater: CT=T×D^{1/2} where T is the number of twists of the reinforcing cord of the carcass layer (times/10 cm), and D is a total fineness of the reinforcing cord of the carcass layer (dtex).

7. The pneumatic tire according to claim 1, wherein the transponder is covered with a coating layer formed of elastomer or rubber, and the coating layer has a relative dielectric constant of 7 or less.

8. The pneumatic tire according to claim 7, wherein a total thickness Gac of the coating layer and a maximum thickness Gar of the transponder satisfy a relationship 1.1≤Gac/Gar≤3.0.

9. The pneumatic tire according to claim 7, wherein the transponder comprises a substrate and antennas extending from both ends of the substrate, the transponder extends along the tire circumferential direction, and a distance L between an end of the antennas in the tire circumferential direction and an end of the coating layer in the tire circumferential direction ranges from 2 mm to 20 mm.

10. The pneumatic tire according to claim 7, wherein the transponder comprises a substrate and antennas extending from both ends of the substrate, and the antennas extend within a range of ±20° with respect to the tire circumferential direction.

11. The pneumatic tire according to claim 7, wherein a center of the transponder in a thickness direction is disposed within a range of from 25% to 75% of a total thickness Gac of the coating layer from a surface on one side of the coating layer in a thickness direction.

12. The pneumatic tire according to claim 2, wherein a center of the transponder is disposed 10 mm or more away from a splice portion of a tire component in the tire circumferential direction.

13. The pneumatic tire according to claim 12, wherein an intermediate elongation EM of the reinforcing cord of the carcass layer at a load of 1.0 cN/dtex is 5.0% or less.

14. The pneumatic tire according to claim 13, wherein a fineness based on corrected weight CF of the reinforcing cord of the carcass layer ranges from 4000 dtex to 8000 dtex.

15. The pneumatic tire according to claim 14, wherein a twist coefficient CT of the reinforcing cord of the carcass layer after dip treatment represented by a formula below is 2000 or greater:
CT=T×D^{1/2}
where T is the number of twists of the reinforcing cord of the carcass layer (times/10 cm), and
D is a total fineness of the reinforcing cord of the carcass layer (dtex).

16. The pneumatic tire according to claim 15, wherein
the transponder is covered with a coating layer formed of elastomer or rubber, and
the coating layer has a relative dielectric constant of 7 or less.

17. The pneumatic tire according to claim 16, wherein a total thickness Gac of the coating layer and a maximum thickness Gar of the transponder satisfy a relationship 1.1≤Gac/Gar≤3.0.

18. The pneumatic tire according to claim 17, wherein
the transponder comprises a substrate and antennas extending from both ends of the substrate,
the transponder extends along the tire circumferential direction, and
a distance L between an end of the antennas in the tire circumferential direction and an end of the coating layer in the tire circumferential direction ranges from 2 mm to 20 mm.

19. The pneumatic tire according to claim 18, wherein
the transponder comprises a substrate and antennas extending from both ends of the substrate, and
the antennas extend within a range of ±20° with respect to the tire circumferential direction.

20. The pneumatic tire according to claim 19, wherein a center of the transponder in a thickness direction is disposed within a range of from 25% to 75% of a total thickness Gac of the coating layer from a surface on one side of the coating layer in a thickness direction.
